(19) United States
(12) Patent Application Publication
(10) Pub. No.: US 2020/0008273 A1
(43) Pub. Date: Jan. 2, 2020

(54) THAWING APPARATUS AND THAWING METHOD

(71) Applicant: SHARP KABUSHIKI KAISHA, Sakai City (JP)

(72) Inventor: MASAYA UEDA, Sakai City (JP)

(21) Appl. No.: 16/452,968

(22) Filed: Jun. 26, 2019

Related U.S. Application Data
(60) Provisional application No. 62/692,437, filed on Jun. 29, 2018.

(51) Int. Cl. H05B 6/50; A23L 3/365; H05B 6/62; H05B 6/54

(52) U.S. Cl. CPC H05B 6/50; H05B 6/54; H05B 6/62; A23L 3/365

(57) ABSTRACT

An object of an embodiment of the present invention is to stop thawing an object at the appropriate time. A temperature measuring device (18) measures the temperature of a matching circuit (13) or a high-frequency power supply (11). A controller unit (21) controls irradiation of an object (22) with radio frequency waves and stopping thereof based on the measured temperature.

### TECHNICAL FIELD

The present invention relates to a thawing apparatus that thaws an object such as frozen food and a thawing method for the same.

### BACKGROUND ART

To date, thawing apparatuses using microwaves have been frequently used to thaw an object such as frozen food. The degree of microwave absorption by water is considerably higher than the degree of microwave absorption by ice. Accordingly, if part of a frozen object melts earlier than the other part during the thawing, the microwave absorption degree in the part rises rapidly. As the result, the thawing in the part is increasingly accelerated, and thereby the overheating in the part is accelerated. This phenomenon is called runaway and causes the object to be unevenly thawed with microwaves. The occurrence of runaway causes the temperature of the surface of the object to differ from the temperature of the inside of the object. This makes it difficult to determine whether the object has been thawed appropriately with the object not destroyed.

To date, thawing apparatuses that thaw an object by using radio frequency waves instead of microwaves have also been proposed. The depth up to which a radio frequency wave or a microwave permeates the object is in inverse proportion to the frequency thereof. The radio frequency wave thus heats the inside of the object more than the microwave does. Further, a difference in absorption degree between water and ice in the radio frequency wave is smaller than that in the microwave, and thus thawing an object with radio frequency waves has an advantage that the object is prevented from being thawed partially.

PTL 1 discloses a high-frequency thawing apparatus including an electrode, a high-frequency power supply that supplies the electrode with power, a reflected-power detection means that is provided at the output end of the high-frequency power supply and that detects power reflected from the electrode, and a display means that performs a display operation in response to output from the reflected-power detection means. PTL 1 further discloses that this high-frequency thawing apparatus enables the operation state of the apparatus to be notified to a user.

### CITATION LIST

### Patent Literature

[PTL 1] Japanese Unexamined Patent Application Publication No. 2004-63308

### SUMMARY OF INVENTION

### Technical Problem

However, the technology disclosed in PTL 1 requires a user of the high-frequency thawing apparatus to determine stopping of the thawing based on their own experiences. It is thus difficult to correctly determine the stopping of the thawing. Consequently, it is also difficult to stop thawing an object at the appropriate time.

An aspect of the present invention aims to stop thawing an object at the appropriate time.

### Solution to Problem

(1) In an embodiment of the present invention, a thawing apparatus includes a casing, a high-frequency power supply, a matching circuit, an electrode, a temperature measuring device, and a controller unit. The casing stores an object that is frozen. The high-frequency power supply generates high-frequency power. The matching circuit adjusts the high-frequency power generated by the high-frequency power supply to obtain matched high-frequency power. The electrode is disposed in the casing and performs irradiation of the object with a radio frequency wave by using the matched high-frequency power. The temperature measuring device measures temperature of the matching circuit or the high-frequency power supply. The controller unit performs control of the irradiation of the object with the radio frequency wave and stopping of the irradiation. The control is performed based on the measured temperature.

(2) In the thawing apparatus of an embodiment of the present invention, in addition to the configuration in (1) above, the temperature measuring device measures the temperature during the irradiation with the radio frequency wave. If the measured temperature exceeds a given threshold, the controller unit causes the irradiation with the radio frequency wave to be stopped.

(3) In the thawing apparatus according to an embodiment of the present invention, in addition to the configuration in (1) above, the temperature measuring device measures the temperature before the irradiation with the radio frequency wave and during the irradiation with the radio frequency wave. If a difference in the measured temperature exceeds a given threshold, the controller unit causes the irradiation with the radio frequency wave to be stopped.

(4) In the thawing apparatus according to an embodiment of the present invention, in addition to the configuration in (1) above, the temperature measuring device measures the temperature before the irradiation with the radio frequency wave and during the irradiation with the radio frequency wave. If a rising rate of the measured temperature exceeds a given threshold, the controller unit causes the irradiation with the radio frequency wave to be stopped.

(5) In an embodiment of the present invention, in addition to the configuration in (1) above, the temperature measuring device measures the temperature before the irradiation with the radio frequency wave and during the irradiation with the radio frequency wave. The controller unit may calculate a heat release amount by integrating a difference in the measured temperature with respect to irradiation time for the radio frequency wave, and further, if the calculated heat release amount exceeds a given threshold, the controller unit may cause the irradiation with the radio frequency wave to be stopped.

(6) In the thawing apparatus according to an embodiment of the present invention, in addition to the configuration in any one of (2) to (5) above, the controller unit causes the irradiation with the radio frequency wave to be stopped by causing the high-frequency power supply to stop generating the high-frequency power.

(7) In the thawing apparatus according to an embodiment of the present invention, in addition to the configuration in any one of (1) to (6) above, the temperature measuring device is a thermistor.

(8) In an embodiment of the present invention, in addition to the configuration in any one of (1) to (7) above, the thawing apparatus further includes a heat sink attached to the matching circuit or the high-frequency power supply. The temperature measuring device is attached to the heat sink and measures the temperature of the matching circuit or the high-frequency power supply by measuring temperature of the heat sink.

(9) In the thawing apparatus according to an embodiment of the present invention, in addition to the configuration in any one of (1) to (8) above, a frequency of the high-frequency power ranges from 3 MHz to 300 MHz.

(10) In an embodiment of the present invention, a thawing method includes thawing a frozen object using the thawing apparatus according to any one of (1) to (5) above.

### Advantageous Effects of Invention

According to an aspect of the present invention, the thawing of the object can be stopped at the appropriate time.

### BRIEF DESCRIPTION OF DRAWINGS

FIG. 1 is a block diagram illustrating the configuration of the chief parts of a thawing apparatus according to Embodiment 1 of the present invention.

FIG. 2 is a diagram illustrating the circuit configuration of a matching circuit according to Embodiment 1 of the present invention.

FIG. 3 is a diagram illustrating the circuit configuration of a thermistor configured as a temperature measuring device according to Embodiment 1 of the present invention.

FIG. 4 is a graph illustrating temporal changes of high-frequency power output from a high-frequency power supply according to Embodiment 1 of the present invention and temporal changes of reflected-wave power.

FIG. 5 is a table illustrating the dissipation factor of the absorption degree of each of a microwave and a radio frequency wave in water and ice.

FIG. 6 is a block diagram illustrating the configuration of the chief parts of a thawing apparatus according to Embodiment 2 of the present invention.

FIG. 7 illustrates pictures depicting results of temperature measurements performed on the high-frequency power supply that are acquired by a thermography device that is the temperature measuring device according to Embodiment 2 of the present invention.

FIG. 8 is a block diagram illustrating the configuration of the chief parts of a thawing apparatus according to Embodiment 3 of the present invention.

### DESCRIPTION OF EMBODIMENTS

### Embodiment 1

(Configuration of Thawing Apparatus 1)

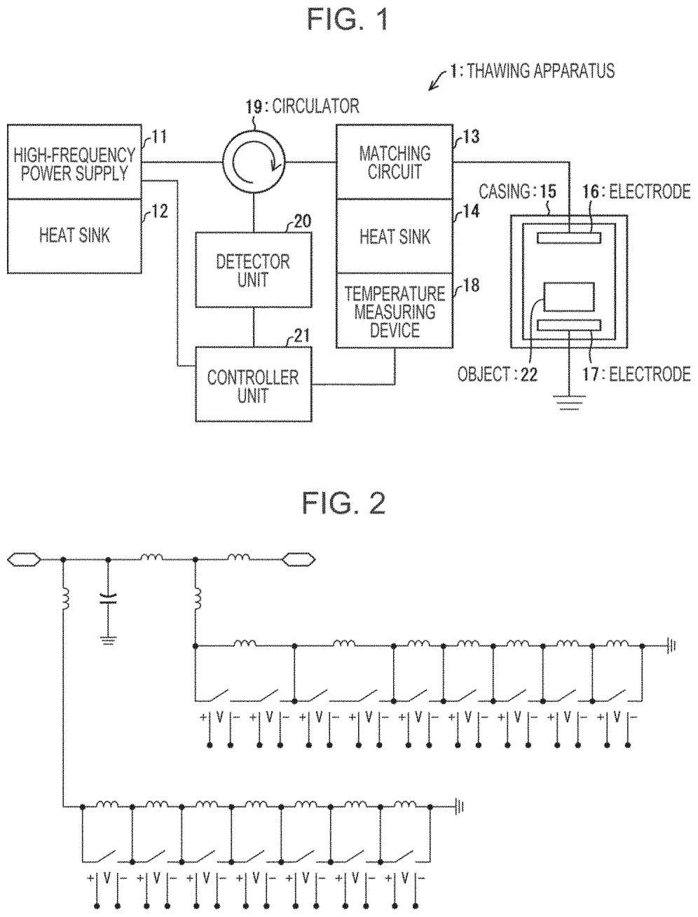

FIG. 1 is a block diagram illustrating the configuration of the chief parts of a thawing apparatus 1 according to Embodiment 1 of the present invention. As illustrated in this figure, the thawing apparatus 1 includes a high-frequency power supply 11, a heat sink 12, a matching circuit 13, a heat sink 14, a casing 15, an electrode 16 and an electrode 17 that are paired, a temperature measuring device 18, a circulator 19, a detector unit 20, and a controller unit 21. The thawing apparatus 1 is an apparatus that thaws a frozen object 22 by irradiating the object 22 with radio frequency waves. The object 22 is, for example, frozen food.

The high-frequency power supply 11 generates high-frequency power by using power input from the outside of the thawing apparatus 1. The high-frequency power supply 11 supplies the generated high-frequency power to the matching circuit 13. In this embodiment, the term “radio frequency wave” denotes an electric signal or an electric wave (electromagnetic wave) ranging from 100 kHz to 300 MHz. The frequency of the high-frequency power generated by the high-frequency power supply 11 preferably ranges from 3 MHz to 300 MHz. This enables the thawing apparatus 1 to irradiate the object 22 with radio frequency waves enabling the object 22 to be heated appropriately. In this embodiment, the high-frequency power supply 11 generates high-frequency power having a frequency of 40 MHz.

The heat sink 12 is attached to the high-frequency power supply 11. The heat sink 12 cools and physically protects the high-frequency power supply 11. The heat sink 12 has, for example, a fin shape, a simple block shape, or a special shape fitted for the high-frequency power supply 11. The material of the heat sink 12 is preferably a metal. The material of the heat sink 12 may be a material other than a metal if the material has a function of conducting the generated heat of the high-frequency power supply 11. The heat capacity of the heat sink 12 is preferably known in advance, regardless of the shape and the material of the heat sink 12. This enables the controller unit 21 to use the temperature measured by the temperature measuring device 18 and to thereby correctly calculate the amount of heat absorbed by the heat sink 12.

The matching circuit 13 adjusts the high-frequency power supplied from the high-frequency power supply 11 to obtain matched high-frequency power. The matching circuit 13 supplies the matched high-frequency power to the electrode 16.

FIG. 2 is a diagram illustrating the circuit configuration of the matching circuit 13 according to Embodiment 1 of the present invention. Since the circuit configuration of the matching circuit 13 illustrated in the figure is known, detailed description thereof is not provided.

The heat sink 14 is attached to the matching circuit 13. The heat sink 14 cools and protects the matching circuit 13. The heat sink 14 has, for example, a fin shape, a simple block shape, or a special shape fitted for the matching circuit 13. The material of the heat sink 14 is preferably a metal. The material of the heat sink 14 may be a material other than a metal if the material has a function of conducting the generated heat of the matching circuit 13. The heat capacity of the heat sink 14 is preferably known in advance, regardless of the shape and the material of the heat sink 14. This enables the temperature measuring device 18 to correctly measure the amount of heat absorbed by the heat sink 14 in Embodiment 1 to be described later.

The casing 15 accommodates therein the object 22 to be thawed by the thawing apparatus 1. The casing 15 further prevents the radio frequency waves from leaking to the outside of the casing 15. The paired electrode 16 and electrode 17 are disposed in the casing 15. The object 22 is disposed between the electrode 16 and the electrode 17 inside the casing 15. The electrode 16 is connected to the matching circuit 13, and the electrode 17 is connected to the ground. The electrode 16 is supplied with the high-frequency power from the matching circuit 13. The electrode 16 and the electrode 17 generate a high-frequency electric field by using the high-frequency power supplied to the electrode 16 and irradiate the object 22 with electric waves (radio frequency waves) according to the generated electric field. The object 22 is thawed by the radio frequency waves used for the irradiation. The electrode 16 reflects part of the supplied high-frequency power and thereby transmits the high-frequency power as reflected-wave power to the matching circuit 13.

(Temperature Measuring Device 18)

The temperature measuring device 18 is attached to the heat sink 14. The temperature measuring device 18 measures the temperature of the heat sink 14 having a known heat capacity and thereby measures a heat release amount that is the amount of heat released from the entire matching circuit 13. As described above, the temperature measuring device 18 indirectly measures the temperature of the matching circuit 13 by measuring the temperature of the heat sink 14. In this embodiment, the temperature measuring device 18 is a thermistor that has a simplified structure and that is used in a simplified manner. The temperature measuring device 18 converts the measured temperature of the heat sink 14 into an analog electric signal and outputs the signal to the controller unit 21.

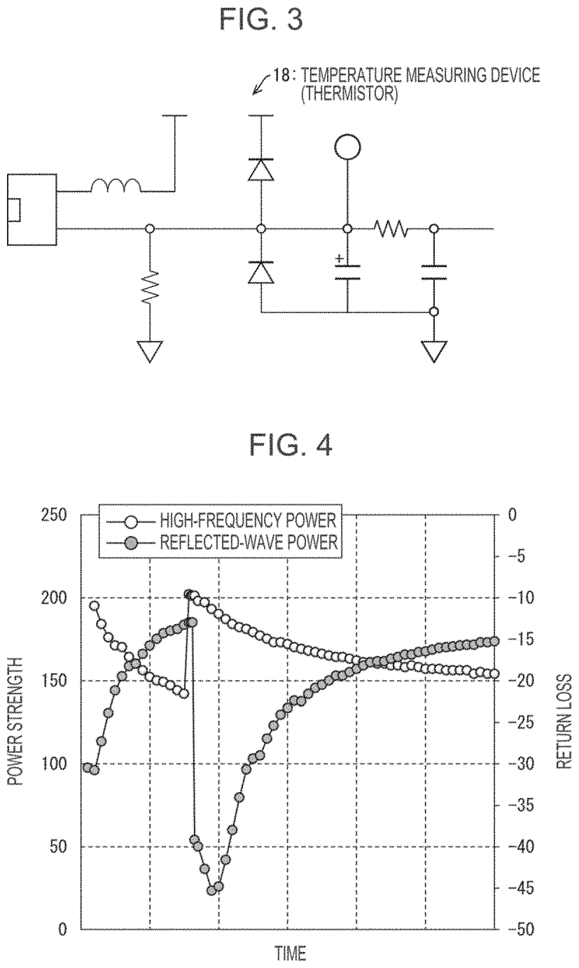

FIG. 3 is a diagram illustrating the configuration of a temperature sensing circuit using a thermistor configured as the temperature measuring device 18 according to Embodiment 1 of the present invention. Since the circuit configuration of the temperature sensing circuit illustrated in FIG. 3 is known, detailed description thereof is not provided.

The temperature measuring device 18 may be directly attached to the matching circuit 13, not to the heat sink 14. The temperature measuring device 18 is attached to, for example, the coil of the matching circuit 13. In this case, the temperature measuring device 18 measures the temperature of part of the matching circuit 13 by measuring the temperature of the coil.

The circulator 19 is disposed between the high-frequency power supply 11 and the matching circuit 13. The circulator 19 decreases the reflected-wave power transmitted from the electrode 16 and the matching circuit 13 to the circulator 19 and transmits the reflected-wave power to the detector unit 20. The detector unit 20 detects the reflected-wave power transmitted from the circulator 19. The detector unit 20 generates information regarding the amount of detected reflected-wave power and outputs the information to the controller unit 21. The detector unit 20 and the circulator 19 are not necessarily required for the thawing apparatus 1.

(Controller Unit 21)

The controller unit 21 collectively controls operations of the thawing apparatus 1. The controller unit 21 is connected at least to the high-frequency power supply 11, the matching circuit 13, the detector unit 20, and the temperature measuring device 18. The controller unit 21 controls operating and stopping of the high-frequency power supply 11 mainly based on the temperature measured by the temperature measuring device 18. The controller unit 21 may further control the output value of the high-frequency power from the high-frequency power supply 11. The controller unit 21 may further control the degree of matching of the high-frequency power by the matching circuit 13. The controller unit 21 may further perform feedback control of the high-frequency power supply 11 and the matching circuit 13 based on the information regarding the amount of the reflected-wave power input from the detector unit 20.

In this embodiment, the controller unit 21 is a microcontroller having a plurality of terminals. The analog electric signal representing the temperature output from the matching circuit 13 is input to a specific terminal of the plurality of terminals. The controller unit 21 performs analog-digital conversion on the analog electric signal input to the specific terminal and thereby acquires a digital value representing the temperature. The controller unit 21 determines time to stop thawing the object 22 by using the acquired digital value.

(Steps for Thawing Object 22)

The thawing apparatus 1 starts thawing the object 22 and determines the stopping of the thawing in accordance with the steps described below.

A user of the thawing apparatus 1 inputs an instruction or an operation to start thawing the object 22 to the controller unit 21. By controlling the high-frequency power supply 11 and the matching circuit 13, the controller unit 21 causes the electrode 16 and the electrode 17 to generate radio frequency waves and to irradiate the object 22 with the radio frequency waves. The thawing of the object 22 is thereby started. In this embodiment, the user may simply input a thawing start instruction to the thawing apparatus 1. Alternatively, together with the thawing start instruction, the user may input a condition to the controller unit 21, such as the mass of the object 22, the temperature before the thawing of the object 22, the target temperature after the thawing of the object 22, or the electric energy of the high-frequency power.

When the object 22 is irradiated with the radio frequency waves, ice included in the object 22 is transformed into water with the radio frequency waves. Since the radio frequency waves permeate the object 22 deeper than microwaves do, the object 22 irradiated with the radio frequency waves is thawed evenly. In the radio frequency waves, a difference between a water absorption degree and an ice absorption degree is smaller than that in the microwaves. Accordingly, the phenomenon in which part of the object 22 melts earlier during the thawing than the other part does is prevented.

The temperature measuring device 18 measures the temperature of the matching circuit 13 at least during the irradiation with the radio frequency waves. With the progress of the thawing of the object 22 caused by the irradiation with the radio frequency waves, the temperature of the matching circuit 13 rises. The temperature measuring device 18 transmits the measured temperature to the controller unit 21. The controller unit 21 determines whether to stop thawing the object 22 based on the temperature transmitted from the temperature measuring device 18. The controller unit 21 determines to stop thawing the object 22 when a temperature rise is detected, for example, based on temperatures transmitted at respective different times. The controller unit 21 thereby causes the generation of the high-frequency power to be stopped by controlling the high-frequency power supply 11. As the result, the thawing of the object 22 is stopped.

The temperature measuring device 18 measures the temperature of the matching circuit 13, for example, during the irradiation with the radio frequency waves. In this case, when the measured temperature exceeds a given threshold, the controller unit 21 causes the high-frequency power supply 11 to stop generating the high-frequency power and thereby causes the irradiation of the object 22 with the radio frequency waves to be stopped. The controller unit 21 can thus cause the thawing of the object 22 to be stopped at the appropriate time. The threshold for the given temperature only needs to be a value stored in advance in the controller unit 21. The controller unit 21 may also calculate the threshold for the temperature by using the condition input to the controller unit 21 by the user, such as the mass of the object 22, the temperature before the thawing of the object 22, the target temperature after the thawing of the object 22, or the electric energy of the high-frequency power.

The temperature measuring device 18 measures the temperature of the matching circuit 13, for example, before the irradiation with the radio frequency waves and during the irradiation with the radio frequency waves. The controller unit 21 calculates a temperature difference by subtracting the temperature before the irradiation from the temperature during the irradiation. If the calculated temperature difference exceeds a given threshold, the controller unit 21 causes the high-frequency power supply 11 to stop generating the high-frequency power and thereby causes the irradiation with the radio frequency waves to be stopped. The controller unit 21 can thus cause the thawing of the object 22 to be stopped at the appropriate time. The threshold for the given temperature difference only needs to be a value stored in advance in the controller unit 21. The controller unit 21 may also calculate the threshold for the temperature difference by using the condition input to the controller unit 21 by the user, such as the mass of the object 22, the temperature before the thawing of the object 22, the target temperature after the thawing of the object 22, or the electric energy of the high-frequency power.

The temperature measuring device 18 measures the temperature of the matching circuit 13, for example, before the irradiation with the radio frequency waves and during the irradiation with the radio frequency waves. The controller unit 21 calculates a temperature difference by subtracting the temperature before the irradiation from the temperature during the irradiation. The controller unit 21 calculates a temperature rise rate by dividing the calculated temperature difference by a time interval between the temperature measurements. If the calculated temperature rise rate exceeds a given threshold, the controller unit 21 causes the high-frequency power supply 11 to stop generating the high-frequency power and thereby causes the irradiation with the radio frequency waves to be stopped. The controller unit 21 can thus cause the thawing of the object 22 to be stopped at the appropriate time. The threshold for the given rising rate only needs to be a value stored in advance in the controller unit 21. The controller unit 21 may also calculate the threshold for the rising rate by using the condition input to the controller unit 21 by the user, such as the mass of the object 22, the temperature before the thawing of the object 22, the target temperature after the thawing of the object 22, or the electric energy of the high-frequency power.

The temperature measuring device 18 measures the temperature of the matching circuit 13, for example, before the irradiation with the radio frequency waves and during the irradiation with the radio frequency waves. The controller unit 21 calculates a temperature difference by subtracting the temperature before the irradiation from the temperature during the irradiation. The controller unit 21 calculates a heat release amount that is the amount of heat released from the matching circuit 13 by integrating the calculated temperature difference with respect to the irradiation time for the radio frequency waves. If the calculated heat release amount exceeds a given threshold, the controller unit 21 causes the high-frequency power supply 11 to stop generating the high-frequency power and thereby causes the irradiation with the radio frequency waves to be stopped. The controller unit 21 can thus cause the thawing of the object 22 to be stopped at the appropriate time. The threshold for the given heat release amount only needs to be a value stored in advance in the controller unit 21. The controller unit 21 may also calculate the threshold for the heat release amount by using the condition input to the controller unit 21 by the user, such as the mass of the object 22, the temperature before the thawing of the object 22, the target temperature after the thawing of the object 22, or the electric energy of the high-frequency power.

(Cause of Temperature Rise at Matching Circuit 13)

In the thawing apparatus 1, it is not known exactly why the temperature of the matching circuit 13 rises with the progress of the thawing of the object 22. The inventors of the present application surmise the cause as follows. When ice included in the object 22 turns to water, the electrical resistance of the object 22 is lowered. The high-frequency power is supplied to the matching circuit 13 and the object 22 from the high-frequency power supply 11. If only the object 22 has a lowered resistance value while the high-frequency power is being supplied, higher load applied by the high-frequency power to the matching circuit 13 causes the occurrence of energy loss in the matching circuit 13. The energy loss is transformed into thermal energy, and thereby the temperature of the matching circuit 13 rises. As described above, when the temperature of the matching circuit 13 rises, the thawing apparatus 1 determines that the thawing of the object 22 is complete and stops thawing the object 22.

FIG. 4 is a graph illustrating temporal changes of the high-frequency power output from the high-frequency power supply 11 according to Embodiment 1 of the present invention and temporal changes of the reflected-wave power. The horizontal axis in FIG. 4 represents time elapsed after the electrode 16 irradiates the object 22 with the radio frequency waves. The vertical axis on the left side of FIG. 4 represents the strength of the high-frequency power output from the high-frequency power supply 11. The vertical axis on the right side of FIG. 4 represents return loss. Return loss has a value in logarithmic expression of a ratio of the reflected-wave power to a travelling wave (high-frequency power).

In a case where the object 22 is thawed with the radio frequency waves, the impedance of the object 22 changes with the progress of the thawing. FIG. 4 illustrates the temporal changes of the results of measurements of the high-frequency power and the reflected-wave power performed in a case where the matching circuit 13 performs impedance matching between the object 22 and the high-frequency power supply 11 during the irradiation of the object 22 with the radio frequency waves. It is understood from FIG. 4 that the reflected-wave power is increased with the further progress of the thawing of the object 22 after the impedance matching is performed. This leads to the following presumption. When ice included in the object 22 turns to water, the impedance of the object 22 changes. The high-frequency power is supplied to the matching circuit 13 and the object 22 from the high-frequency power supply 11, and a change in the impedance of only the object 22 leads to an increase in the reflected-wave power transmitted to the matching circuit 13. The reflected-wave power is transformed into heat according to the high-frequency power supply 11, the parasitic capacitance, the parasitic inductance, and the like in or near the matching circuit 13. The temperature measuring device 18 detects the heat and thereby measures the temperature of the matching circuit 13.

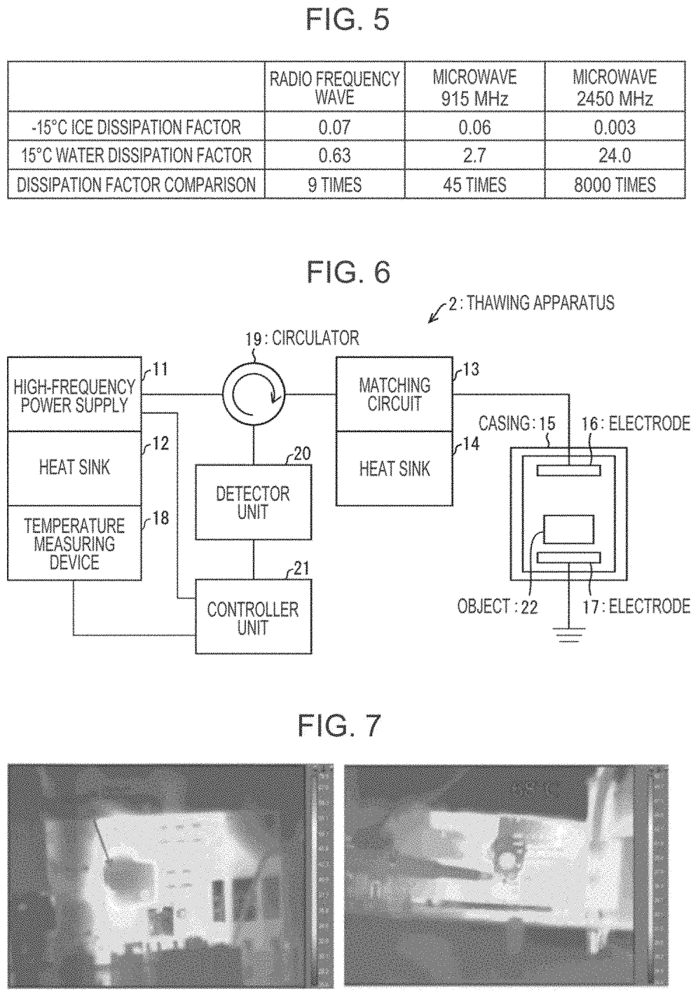

FIG. 5 is a table illustrating the dissipation factor of the absorption degree of each of a microwave and a radio frequency wave in water and ice. The properties of a dielectric are represented by a dielectric constant and a dielectric power factor. The dissipation factor is the product of the dielectric constant and the dielectric power factor. The dissipation factor is an index for how easily an object is heated with electric waves. The dissipation factor varies depending on the frequency of electric waves used for irradiating the object and the temperature of the object 22. The calorific value of an object is in proportion to the frequency of electric waves used for the irradiation and the dissipation factor of the object and is in inverse proportion to squared strength of the electric field. In contrast, how deep an electric wave permeates into the object is in inverse proportion to the frequency of the electric wave. Accordingly, to thaw the object evenly, it is more advantageous to use a radio frequency wave having a lower frequency than that of a microwave.

As illustrated in FIG. 5, regarding dielectric losses of water and ice in the case of irradiation with a microwave, water has an extremely higher dielectric loss than ice does. Accordingly, in the conventional technology for thawing an object with microwaves, when ice included in part of the object melts and turns to water, the dissipation factor of the part is changed extremely largely, and thus the change leads to an extremely rapid change in the microwaves absorbed into the object. Accordingly, it is difficult in the conventional technology to sense the temperature of the matching circuit by using a thermistor having a low temperature sensing rate.

As illustrated in FIG. 5, the dielectric loss difference between water and ice in the case of irradiation with the radio frequency wave is sufficiently smaller than that in the case of irradiation with the microwave. Accordingly, in the thawing apparatus 1 that thaws the object 22 with the radio frequency waves, when ice included in part of the object 22 melts and turns to water, the dissipation factor of the part is changed mildly. Further, how deep the radio frequency waves permeate into the object 22 is in inverse proportion to the frequency of the radio frequency waves. Accordingly, the change in the radio frequency waves absorbed into the object 22 is milder than that in the microwaves. From these, the thawing apparatus 1 may measure the temperature of the matching circuit 13 by using, as the temperature measuring device 18, a thermistor that has a low temperature sensing rate but that is inexpensive.

As illustrated in FIG. 3, the thermistor has a smaller number of components even if peripheral components are included in the counting. The thermistor can thus be configured inexpensively. Since the thawing apparatus 1 has the inexpensive thermistor as the temperature measuring device 18, the cost of the thawing apparatus 1 can be reduced.

As described above, the thawing apparatus 1 can stop thawing the object 22 at the appropriate time by using an inexpensive measure.

### Embodiment 2

FIG. 6 is a block diagram illustrating the configuration of the chief parts of a thawing apparatus 2 according to Embodiment 2 of the present invention. As illustrated in this figure, the thawing apparatus 2 includes the same members as the members included in the thawing apparatus 1 according to Embodiment 1. However, the thawing apparatus 2 is different from the thawing apparatus 1 according to Embodiment 1 in that the temperature measuring device 18 is attached to the heat sink 12, not to the heat sink 14. In the thawing apparatus 2, the temperature measuring device 18 measures the temperature of the heat sink 12 having a known heat capacity and thereby measures the amount of heat released from the entire high-frequency power supply 11. As described above, the temperature measuring device 18 indirectly measures the temperature of the high-frequency power supply 11 by measuring the temperature of the heat sink 12.

The temperature measuring device 18 may be directly attached to the high-frequency power supply 11, not to the heat sink 12. The temperature measuring device 18 is attached to, for example, the coil of the high-frequency power supply 11. In this case, the temperature measuring device 18 measures the temperature of part of the high-frequency power supply 11 by measuring the temperature of the coil of the high-frequency power supply 11.

If the resistance value of only the object 22 is decreased due to the irradiation with the radio frequency waves in the thawing apparatus 2, the reflected-wave power transmitted to the high-frequency power via the circulator 19 is increased. The reflected-wave power is transformed into heat in the high-frequency power, and the temperature measuring device 18 detects the heat and thereby measures the temperature of the high-frequency power supply 11. The temperature measuring device 18 transmits the measured temperature of the high-frequency power supply 11 to the controller unit 21. The controller unit 21 can determine time to stop thawing the object 22 based on the transmitted temperature.

The temperature measuring device 18 may be a thermography device, instead of a thermistor. Also in this case, the temperature measuring device 18 can measure the temperature of the high-frequency power supply 11 correctly. FIG. 7 illustrates pictures depicting results of temperature measurements performed on the high-frequency power supply 11 that are acquired by a thermography device that is the temperature measuring device according to Embodiment 2 of the present invention. In a case where the temperature measuring device 18 is a thermography device, the temperature measuring device 18 acquires temperature measurement results (thermograph) as illustrated in, for example, FIG. 7 and outputs the results to the controller unit 21. The controller unit 21 controls the irradiation with the radio frequency waves and stopping thereof based on the thermograph input from the temperature measuring device 18.

The method by which the controller unit 21 according to this embodiment determines time to stop thawing the object 22 is basically the same as the method disclosed in Embodiment 1. The controller unit 21 can thus appropriately determine time to stop thawing the object 22.

If the thawing apparatus 1 does not include the circulator 19, the reflected-wave power transmitted to the high-frequency power supply 11 is increased compared with the case where the circulator 19 is included. The devising according to this embodiment is more effective to the thawing apparatus 1 without the circulator 19.

### Embodiment 3

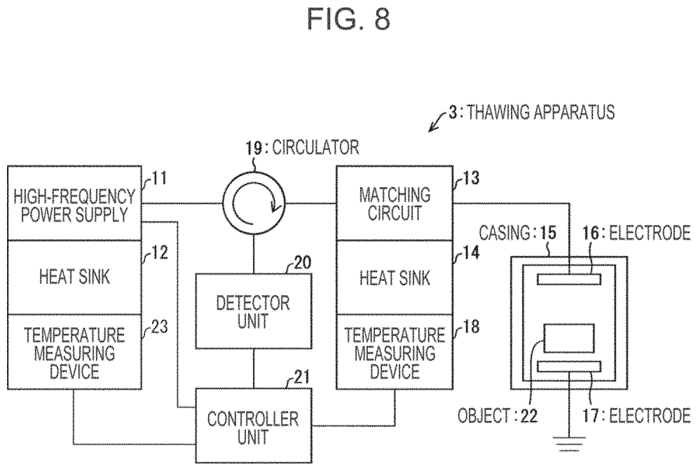

FIG. 8 is a block diagram illustrating the configuration of the chief parts of a thawing apparatus 3 according to Embodiment 3 of the present invention. As illustrated in this figure, the thawing apparatus 3 includes a temperature measuring device 23 in addition to the members included in the thawing apparatus 1 according to Embodiment 1. In the thawing apparatus 3, the temperature measuring device 18 is attached to the heat sink 14, and the temperature measuring device 23 is attached to the heat sink 12. The controller unit 21 is connected at least to the high-frequency power supply 11, the matching circuit 13, the temperature measuring device 18, the detector unit 20, and the temperature measuring device 23. The temperature measuring device 18 measures the temperature of the heat sink 14 as in Embodiment 1 and thereby indirectly measures the temperature of the matching circuit 13. The temperature measuring device 23 measures the temperature of the heat sink 12 and thereby indirectly measures the temperature of the high-frequency power supply 11. The temperature measuring device 23 transmits the measured temperature to the controller unit 21.

Based on both of the temperature of the matching circuit 13 measured by the temperature measuring device 18 and the temperature of the high-frequency power supply 11 measured by the temperature measuring device 23, the controller unit 21 controls the irradiation of the object 22 with the radio frequency waves and stopping thereof. This enables the controller unit 21 to more correctly determine time to stop thawing the object 22. The controller unit 21 calculates a first heat release amount by integrating a temperature difference (temperature rise value) between, for example, before and after the irradiation with the radio frequency waves in the matching circuit 13 with respect to irradiation time. The controller unit 21 further calculates a second heat release amount by integrating a temperature difference (temperature rise value) between before and after the irradiation with the radio frequency waves in the high-frequency power supply 11 with respect to the irradiation time. Based on the total heat release amount that is a value obtained by adding up the first heat release amount and the second heat release amount, the controller unit 21 controls the irradiation with the radio frequency waves and stopping thereof. This enables the controller unit 21 to more correctly determine time to stop the thawing. If, for example, the total heat release amount exceeds a given threshold, the controller unit 21 controls the high-frequency power supply 11 and thereby causes the irradiation with the radio frequency waves from the electrode 16 to be stopped. As the result, the object 22 is thawed more appropriately.

The present disclosure is not limited to the embodiments described above. Various modifications may be made within the scope of claims. An embodiment obtained by appropriately combining technical measures disclosed in different embodiments is also included in the technical scope of the present disclosure. Further, a new technical feature may be created by combining technical measures disclosed in the embodiments.

### REFERENCE SIGNS LIST

1, 2, 3 thawing apparatus
11 high-frequency power supply
12, 14 heat sink
13 matching circuit
15 casing
16, 17 electrode
18, 23 temperature measuring device
19 circulator
20 detector unit
21 controller unit
22 object

What is claimed is:

1. A thawing apparatus comprising:
a casing that stores an object that is frozen;
a high-frequency power supply that generates high-frequency power;
a matching circuit that adjusts the high-frequency power generated by the high-frequency power supply to obtain matched high-frequency power;
an electrode disposed in the casing, the electrode performing irradiation of the object with a radio frequency wave by using the matched high-frequency power;
a temperature measuring device that measures temperature of the matching circuit or the high-frequency power supply; and
a controller unit that performs control of the irradiation of the object with the radio frequency wave and stopping of the irradiation, the control being performed based on the measured temperature.

2. The thawing apparatus according to claim 1,
wherein the temperature measuring device measures the temperature during the irradiation with the radio frequency wave, and
wherein if the measured temperature exceeds a given threshold, the controller unit causes the irradiation with the radio frequency wave to be stopped.

3. The thawing apparatus according to claim 1,
wherein the temperature measuring device measures the temperature before the irradiation with the radio frequency wave and during the irradiation with the radio frequency wave, and
wherein if a difference in the measured temperature exceeds a given threshold, the controller unit causes the irradiation with the radio frequency wave to be stopped.

4. The thawing apparatus according to claim 1,
wherein the temperature measuring device measures the temperature before the irradiation with the radio frequency wave and during the irradiation with the radio frequency wave, and
wherein if a rising rate of the measured temperature exceeds a given threshold, the controller unit causes the irradiation with the radio frequency wave to be stopped.

5. The thawing apparatus according to claim 1,
wherein the temperature measuring device measures the temperature before the irradiation with the radio frequency wave and during the irradiation with the radio frequency wave, and
wherein the controller unit calculates a heat release amount by integrating a difference in the measured temperature with respect to irradiation time for the radio frequency wave, and further, if the calculated heat release amount exceeds a given threshold, the controller unit causes the irradiation with the radio frequency wave to be stopped.

6. The thawing apparatus according to claim 2,
wherein the controller unit causes the irradiation with the radio frequency wave to be stopped by causing the high-frequency power supply to stop generating the high-frequency power.

7. The thawing apparatus according to claim 1,
wherein the temperature measuring device is a thermistor.

8. The thawing apparatus according to claim 1
further comprising:
a heat sink attached to the matching circuit or the high-frequency power supply,
wherein the temperature measuring device is attached to the heat sink and measures the temperature of the matching circuit or the high-frequency power supply by measuring temperature of the heat sink.

9. The thawing apparatus according to claim 1,
wherein a frequency of the high-frequency power ranges from 3 MHz to 300 MHz.

10. A thawing method comprising thawing a frozen object by using the thawing apparatus according to claim 1.
